(19) United States
(12) Patent Application Publication
(10) Pub. No.: US 2025/0210278 A1
(43) Pub. Date: Jun. 26, 2025

(54) TANTALUM CAPACITOR

(71) Applicant: SAMSUNG ELECTRO-MECHANICS CO., LTD., Suwon-si (KR)

(72) Inventors: Min Sung KIM, Suwon-si (KR); Hee Sung CHOI, Suwon-si (KR)

(73) Assignee: SAMSUNG ELECTRO-MECHANICS CO., LTD., Suwon-si (KR)

(21) Appl. No.: 18/950,799

(22) Filed: Nov. 18, 2024

(30) Foreign Application Priority Data
Dec. 21, 2023 (KR) 10-2023-0188722

(51) Int. Cl. H01G 9/10; H01G 9/012; H01G 9/04; H01G 9/042; H01G 9/052; H01G 9/15

(52) U.S. Cl. CPC H01G 9/10; H01G 9/012; H01G 9/042; H01G 9/0525; H01G 9/15; H01G 2009/05

(57) ABSTRACT

A tantalum capacitor includes a tantalum body including a tantalum element body including tantalum powder, a conductive polymer layer disposed on the tantalum element body, the conductive polymer layer including a first filler, and a tantalum wire. The first filler may be an insulating polymer filler.

### CROSS-REFERENCE TO RELATED APPLICATION(S)

This application claims benefit of priority to Korean Patent Application No. 10-2023-0188722 filed on Dec. 21, 2023 in the Korean Intellectual Property Office, the disclosure of which is incorporated herein by reference in its entirety.

### TECHNICAL FIELD

The present disclosure relates to a tantalum capacitor, more specifically, to a tantalum capacitor having improved reliability by reducing an amount of moisture absorption while maximally preventing an increase in equivalent series resistance.

A tantalum (Ta) material is a metal widely used across industries, including in the electrical and electronics, machinery, chemical engineering, medical, aerospace, and defense industries, due to mechanical and physical characteristics thereof, such as high melting point, excellent ductility and corrosion resistance.

In particular, tantalum has been widely used as an anode material for small-sized capacitors due to characteristics thereof which form the most stable anodized film, among all metals.

Moreover, the use of a tantalum material has rapidly increased annually, due to the recent rapid development of IT industries, such as electronics, information and communication, and the like.

A tantalum capacitor may have a structure using a gap occurring when tantalum powder is sintered and cured, and Ta₂O₅ may be formed on a tantalum surface as an electrode metal using an anodic oxidation method, and may be used as a dielectric, and a manganese dioxide layer (MnO₂) or a conductive polymer layer may be formed thereon as a solid electrolyte.

In addition, due to the derivation of an anode, a carbon layer and a silver (Ag) layer, a metal layer, may be formed on the manganese dioxide (MnO₂) layer or the conductive polymer layer.

Tantalum capacitors may have a low equivalent series resistance (ESR) and a high ripple current rating.

As a result, Tantalum capacitors may have more excellent temperature dependence and a longer service lifespan than those of aluminum electrolytic capacitors.

However, the high moisture absorption properties of a conductive polymer layer may affect reliability evaluation, and additional solutions may be necessary to improve the performance of a polymer itself.

### SUMMARY

An aspect of the present disclosure provides a tantalum capacitor having excellent reliability by lowering moisture absorption while effectively suppressing an increase in equivalent series resistance.

Another aspect of the present disclosure provides a tantalum capacitor having improved reliability in a high temperature or high humidity environment.

According to an aspect of the present disclosure, there is provided a tantalum capacitor including a tantalum body including a tantalum element body including tantalum particles, a conductive polymer layer disposed on the tantalum element body, the conductive polymer layer including a first filler, and a tantalum wire. The first filler may be an insulating polymer filler.

According to example embodiments of the present disclosure, a tantalum capacitor may have excellent reliability by lowering moisture absorption while effectively suppressing an increase in equivalent series resistance.

According to example embodiments of the present disclosure, a tantalum capacitor may have improved reliability in a high temperature or high humidity environment.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a tantalum capacitor according to the present disclosure;

FIG. 2 is a side view of a tantalum capacitor according to the present disclosure;

FIG. 3 is a top view of a tantalum body in a tantalum capacitor according to the present disclosure;

FIG. 4 is a cross-sectional view taken along line I-I′ in FIG. 3;

FIG. 5 is an enlarged view of region “A” in FIG. 4;

FIG. 6 is a schematic cross-sectional view of a structure of the first filler in FIG. 5;

FIG. 7 is a graph illustrating behavior of an equivalent series resistance (ESR) according to a content of a first filler (silicone-epoxy copolymer);

FIG. 8 is a graph illustrating behavior of a moisture absorption rate according to a content of a first filler (silicone-epoxy copolymer);

FIG. 9 is a graph illustrating behavior of an amorphous charge current (ACC) according to a content of a first filler (silicone-epoxy copolymer);

FIG. 10 is a graph illustrating behavior of an equivalent series resistance (ESR) according to a content of a first filler (core-shell rubber);

FIG. 11 is a graph illustrating behavior of a moisture absorption rate according to a content of a first filler (core-shell rubber); and

FIG. 12 is an enlarged view of region “A” in FIG. 4 of a tantalum capacitor according to a modification.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

Hereinafter, preferred example embodiments of the present disclosure will be described with reference to the accompanying drawings.

In the drawings, an X-direction may be defined as a first direction, an L-direction, or a length direction, a Y-direction may be defined as a second direction, a W-direction, or a width direction, and a Z-direction may be defined as a third direction, a T-direction, or a thickness direction.

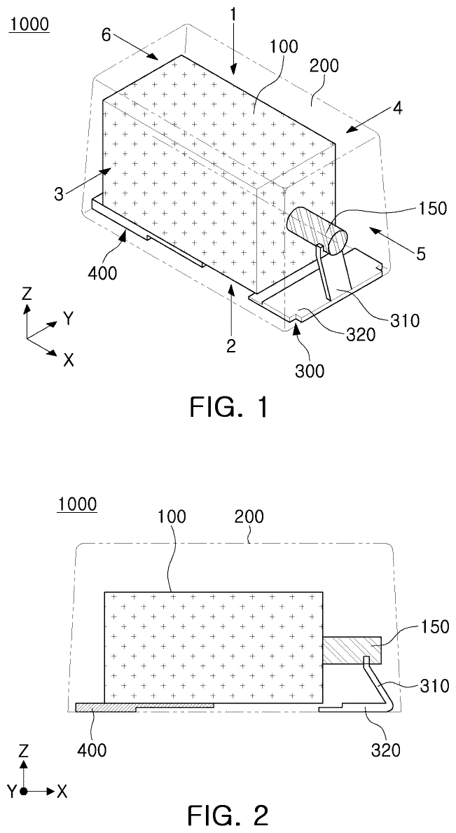

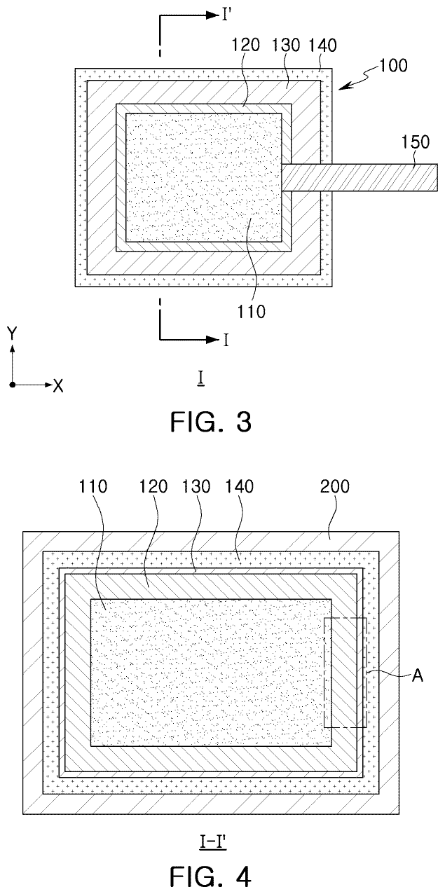

FIG. 1 is a perspective view of a tantalum capacitor according to the present disclosure. FIG. 2 is a side view of a tantalum capacitor according to the present disclosure. FIG. 3 is a top view of a tantalum body in a tantalum capacitor according to the present disclosure.

Referring to FIG. 1, a tantalum capacitor 1000 according to the present example embodiment may include a tantalum body 100, and may further include a molded portion 200, an anode lead frame 300, and a cathode lead frame 400.

The tantalum body 100 may have a tantalum wire 150 exposed in the first direction (X-direction) of the tantalum body 100. Here, the tantalum wire 150 may pass through at least a portion of the tantalum element body 110 in the second direction (Y-direction). The tantalum wire 150 may be inserted into and installed in a mixture of tantalum powder and a binder to be off-centered before the mixture of the tantalum powder and the binder is compressed. That is, the tantalum body 100 may be manufactured by insertedly installing the tantalum wire 150 in the tantalum powder mixed with the binder, forming a tantalum element having a desired size, and then sintering the tantalum element in a high temperature and high vacuum (10-5 torr or less) atmosphere for about 30 minutes.

The molded portion 200 may have fifth and sixth surfaces 5 and 6 opposing each other in the first direction, third and fourth surfaces 3 and 4 opposing each other in the second direction, and first and second surfaces 1 and 2 opposing each other in the third direction, and may be formed to surround the tantalum body 100.

The molded portion 200 may cover the tantalum body 100, and may be formed to expose one surface of a first connection portion 320 of the anode lead frame 300 and one surface of the anode lead frame 400.

The molded portion 200 of the tantalum capacitor according to the present disclosure may be formed by transfer-molding a resin, such as an epoxy molding compound (EMC) or the like, to surround the tantalum body 100. The molded portion 200 may serve to protect the tantalum wire 150 and the tantalum body 100 from the outside.

The anode lead frame 300 may be connected to the tantalum wire 150 to serve as a terminal when mounted on a board. The anode lead frame 300 may include the first connection portion 320, a first bent portion 310, and the first bent portion 310 may be inclined toward the tantalum body 100 with respect to the first connection portion 320. The first connection portion 320 of the anode lead frame 300 may be exposed from a lower surface of the molded portion 200. The first connection portion 320 may be exposed from the second surface 2 of the molded portion 200 to serve as a terminal when mounted on a board. In this case, the first connection portion 320 may be spaced apart from the tantalum body 100, and may function as an anode of the tantalum capacitor 1000 according to the present disclosure. To this end, the anode lead frame 300 may be formed of a conductive metal such as a nickel/iron alloy.

The cathode lead frame 400 may be connected to the tantalum body 100 to serve as a terminal when mounted on a board. The cathode lead frame 400 may be spaced apart from the anode lead frame 300 to be parallel to the anode lead frame 300 in the second direction (Y-direction). The cathode lead frame 400 may be exposed from the second surface 2 of the molded portion 200. The cathode lead frame 400 may be exposed from the second surface 2 of the molded portion 200 to serve as a terminal when mounted on a board, and may function as a cathode of the tantalum capacitor 1000 according to the present disclosure. To this end, the cathode lead frame 400 may be formed of a conductive metal such as a nickel/iron alloy.

Although not illustrated in the drawings, the tantalum capacitor according to an example embodiment of the present disclosure may further include a conductive adhesive layer to bond the cathode lead frame 400 and the tantalum body 100 to each other. The conductive adhesive layer may be formed by, for example, coating and curing a certain amount of a conductive adhesive including an epoxy-based thermosetting resin and conductive metal powder such as silver (Ag), but the present disclosure is not limited thereto.

Hereinafter, a structure of the tantalum body 100 will be described in detail with reference to FIGS. 3 and 4.

FIG. 3 is a top view of a tantalum body in a tantalum capacitor according to the present disclosure. FIG. 4 is a cross-sectional view taken along line I-I′ in FIG. 3.

The tantalum body 100 according to the present disclosure may include a tantalum element body 110 including tantalum powder, a conductive polymer layer 120 disposed on the tantalum element body 110, the conductive polymer layer 120 including a first filler 121, a carbon layer 130 disposed on the conductive polymer layer, and a silver (Ag) layer 140 disposed on the carbon layer.

The tantalum capacitor may include the tantalum wire 150 having an insertion region positioned on the inside of the tantalum element body 110, and a non-insertion region positioned on the outside of the tantalum element body 110.

The tantalum element body 110 may be formed by sintering a molded body including metal powder and a binder.

Specifically, the tantalum element body 110 may be manufactured by mixing metal powder, a binder, and a solvent at a predetermined ratio, stirring mixed powder, compressing the mixed powder to form the mixed powder having a rectangular parallelepiped shape, and then sintering the same under high temperature and high vibration.

The metal powder is not limited as long as it may be used in the tantalum element body 110 of the tantalum capacitor 1000 according to an example embodiment of the present disclosure, and may be tantalum (Ta) powder. However, the present disclosed is not limited thereto, the metal powder may be one or more selected from the group consisting of aluminum (Al), niobium (Nb), vanadium (V), titanium (Ti), and zirconium (Zr), and accordingly, an aluminum element body, a niobium element body, or the like may also be used, instead of a tantalum element body.

The binder is not limited, and may be, for example, a cellulose-based binder.

The cellulose-based binder may be one or more selected from the group consisting of nitrocellulose, methyl cellulose, ethyl cellulose, and hydroxy propyl cellulose.

In addition, the tantalum wire 150 may be inserted into and installed in the mixed powder to be off-centered, before the mixed powder is compressed.

According to an example embodiment of the present disclosure, a dielectric oxide layer may be formed on the tantalum element body 110, as an insulating layer. That is, the dielectric oxide layer may be formed by growing an oxide film (Ta₂O₅) on a surface of the tantalum element body 110 through a formation process using an electrochemical reaction. Here, the dielectric oxide layer may change the tantalum element body 110 into a dielectric. In addition, the conductive polymer layer 120 having a negative polarity may be coated and formed on the dielectric oxide layer.

The conductive polymer layer 120 is not limited, and may include, for example, a conductive polymer.

Specifically, the conductive polymer may be formed using chemical polymerization or electrolytic polymerization using 3,4-ethylenedioxythiophene (EDOT), a pyrrole monomer, or polypyrrole, and may then be formed on an external surface of the tantalum element body 110 formed as an insulating layer, as a cathode layer having a conductive polymer cathode.

That is, the conductive polymer layer 120 may be formed using a polymer slurry, and the polymer slurry may include at least one of polypyrrole, polyaniline, or 3,4-ethylenedioxythiophene (EDOT). In addition, the conductive polymer layer 120 may poly(3,4-ethylenedioxythiophene): poly(styrenesulfonate) (PEDOT: PSS). include PEDOT: PSS may be prepared by oxidative polymerization of EDOT using polystyrene sulfonate (PSS) as a template for balancing an electric charge.

According to an example of the present disclosure, the conductive polymer layer 120 may include the first filler 121, and the first filler 121 may have a core-shell structure. The first filler 121 of the conductive polymer layer 120 will be described below.

The carbon layer 130 may be laminated on the conductive polymer layer 120, and may be laminated by dissolving carbon powder in an organic solvent including an epoxy resin, impregnating the tantalum element body 110 in the solution in which the carbon powder is dissolved, and then, perform drying thereon at a predetermined temperature to volatilize the organic solvent.

In addition, the carbon layer 130 may serve to prevent silver (Ag) ions from passing therethrough.

Then, the silver (Ag) layer 140, formed of silver (Ag) paste, may be included on an upper surface of the carbon layer 130.

The silver (Ag) layer 140 may be laminated on the outside of the carbon layer 130 to improve conductivity.

In addition, the silver (Ag) layer 140 may improve conductivity with respect to a polarity of a cathode layer, thereby facilitating electrical connection for polarity transfer.

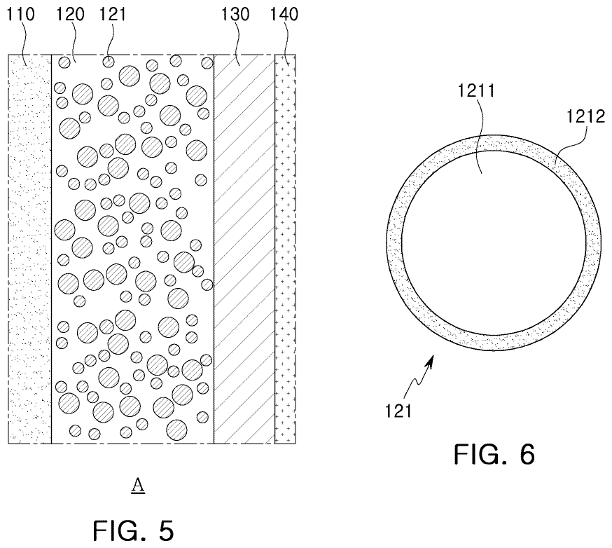

FIG. 5 is an enlarged view of region “A” in FIG. 4.

Referring to FIG. 5, the conductive polymer layer 120 according to the present disclosure may include the first filler 121, an insulating polymer.

The first filler 121 may be dispersed in the conductive polymer layer 120, and may be a silicone-epoxy copolymer or a core-shell rubber. That is, the first filler 121 may be an insulating organic polymer.

In a tantalum capacitor according to the related art, a conductive polymer layer may have high moisture absorption properties, such that the capacitor may have low reliability. In the present disclosure, the first filler 121, an insulating polymer, may be dispersed in the conductive polymer layer 120, thereby effectively lowering a moisture absorption rate of the conductive polymer layer 120. In addition, the conductive polymer layer 120 according to the present disclosure may include the first filler 121 having insulating properties, thereby preventing a flow of current causing leakage current (LC) and increasing strength of the conductive polymer layer 120 to improve overall characteristics of the tantalum capacitor 1000.

FIG. 6 is a schematic cross-sectional view of a structure of the first filler in FIG. 5.

Referring to FIG. 6, a structure of the first filler 121 of the tantalum capacitor 1000 according to the present disclosure is illustrated in detail.

The first filler 121 may have a core-shell structure. Specifically, the first filler 121 may include an inner core region 1211 and an outer shell region 1212 covering the core region.

When the first filler 121 is a silicone-epoxy copolymer, the core region 1211 may be formed of epoxy, and the shell region 1212 may be formed of silicone. More specifically, the silicone-epoxy copolymer, a copolymer of epoxy and silicone, may be a polymer having an end group including silicone (silane or siloxane). When the silicone-epoxy copolymer is dispersed and dried in the conductive polymer layer 120, epoxy and silicone may be divided into respective regions. More specifically, the inside and the outside of the first filler may respectively include epoxy and silicone, and may have a core-shell structure. The composition of the core and the shell may be observed by energy-dispersive X-ray spectroscopy (EDS) in combination with an electron microscope. Other methods and/or tools appreciated by one of ordinary skill in the art, even if not described in the present disclosure, may also be used.

When the first filler 121 is a core-shell rubber, the core region 1211 may include at least one from the group consisting of butadiene rubber, acrylic rubber, and silicone rubber, and the shell region 1212 of the first filler may include at least one from the group consisting of methyl methacrylate and styrene.

The first filler 121 may be added to a polymer slurry when the conductive polymer layer 120 is formed. Specifically, a solution in which the first filler 121 is completely dissolved or dispersed may be mixed with the polymer slurry, using methyl ethyl ketone (MEK), a polar solvent.

The first filler 121 manufactured in the above-described manner may be dispersed in the conductive polymer layer 120 to improve internal pressure characteristics, to improve breakdown voltage (BDV) characteristics, and to effectively prevent leakage current (LC).

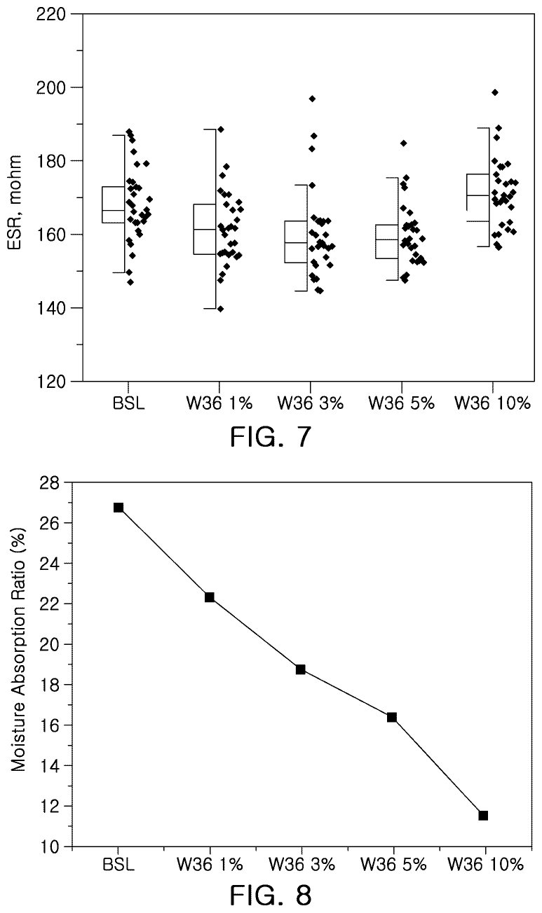

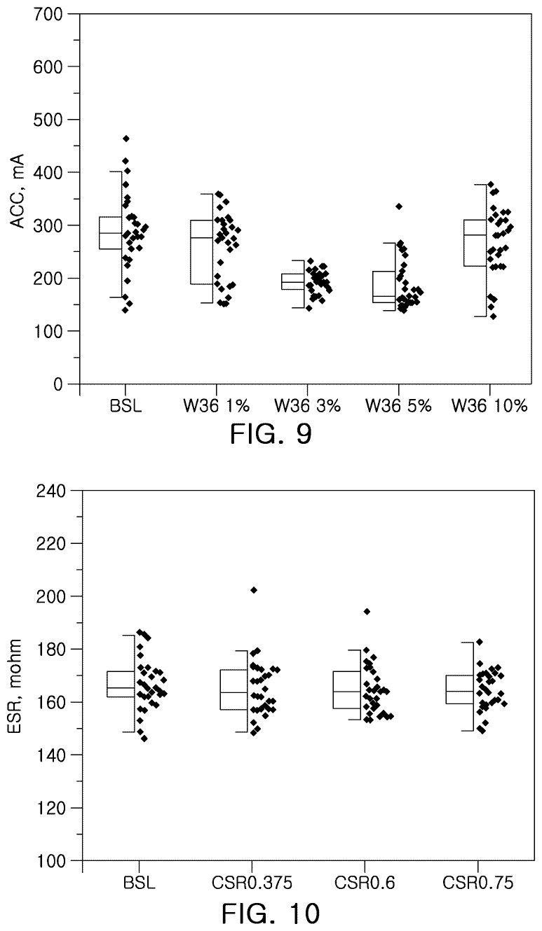

FIG. 7 is a graph illustrating behavior of an equivalent series resistance (ESR) according to a content of a first filler (silicone-epoxy copolymer). FIG. 8 is a graph illustrating behavior of a moisture absorption rate according to a content of a first filler (silicone-epoxy copolymer). FIG. 9 is a graph illustrating behavior of an amorphous charge current (ACC) according to a content of a first filler (silicone-epoxy copolymer). The conductive polymer layer may include a silicone-epoxy copolymer, as the first filler 121, in an amount greater than 0 wt % and less than or equal to 10 wt %, based on a total weight of the conductive polymer layer. When converted into a cross-sectional area ratio, a ratio of an area of the first filler to an area of the conductive polymer layer may satisfy greater than 0 and less than or equal to 0.0976 with respect to one cross-section of the conductive polymer layer.

More preferably, the conductive polymer layer may include a silicone-epoxy copolymer in an amount of 1 wt % or more and 5 wt % or less, as the first filler 121. When converted into a cross-sectional area ratio, the ratio of the area of the first filler to the area of the conductive polymer layer may satisfy 0.00976 or more and 0.0488 or less with respect to the one cross-section of the conductive polymer layer.

Referring to FIGS. 7 to 9, when the first filler 121 includes a silicone-epoxy copolymer in an amount greater than 0 wt % and less than or equal to 10 wt %, an equivalent series resistance (ESR), a moisture absorption rate, and an anomalous charge current (ACC) may be improved, as compared to a comparative example (BSL). Here, the comparative example refers to a tantalum capacitor, not including an insulating polymer as a filler.

Referring to FIGS. 7 to 9, the moisture absorption rate decreased as the first filler 121 (silicone-epoxy copolymer) is added. Conversely, the improvement of the equivalent series resistance (ESR) and the acoustic charge current (ACC) decreased and then increased as the first filler 121 was added. Specifically, the equivalent series resistance (ESR) had a minimum value when 3 wt % of the first filler 121 (silicone-epoxy copolymer) is added, and had a value similar to that of the comparative example when 10 wt % of the first filler 121 (silicone-epoxy copolymer) was added. The anomalous charge current (ACC) had a minimum value when 5 wt % of the first filler 121 (silicone-epoxy copolymer) was added, and had a value similar to that of the comparative example when 10 wt % of the first filler 121 (silicone-epoxy copolymer) was added.

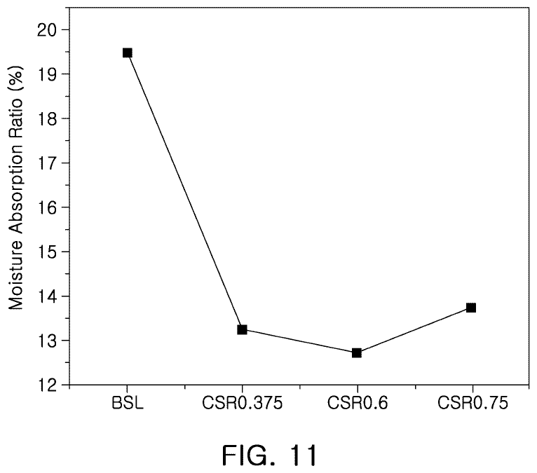

FIG. 10 is a graph illustrating behavior of an equivalent series resistance (ESR) according to a content of a first filler (core-shell rubber). FIG. 11 is a graph illustrating behavior of a moisture absorption rate according to a content of a first filler (core-shell rubber).

The conductive polymer layer may include a core-shell rubber as the first filler 121 in an amount greater than 0 wt % and less than or equal to 0.75 wt %. When converted into a cross-sectional area ratio, a ratio of an area of the first filler to an area of the conductive polymer layer may be greater than or equal to 0 and less than or equal to 0.00734 with respect to one cross-section of the conductive polymer layer.

More preferably, the conductive polymer layer may include a core-shell rubber in an amount of 0.375 wt % or more and 0.6 wt % or less, as the first filler 121. When converted into a cross-sectional area ratio, a ratio of an area of the first filler to an area of the conductive polymer layer may be 0.00368 to 0.00588.

Referring to FIGS. 10 and 11, when the core-shell rubber is included in an amount greater than 0 wt % and equal to or less than 0.75 wt %, as the first filler 121, it can be confirmed that the equivalent series resistance (ESR) and the moisture absorption rate was improved, as compared to the comparative example (BSL). Here, the comparative example refers to a tantalum capacitor, not including an insulating polymer as a filler.

Referring to FIGS. 10 and 11, the equivalent series resistance (ESR) and the moisture absorption rate decreased and then increased as the first filler 121 (core-shell rubber) was added. Specifically, the equivalent series resistance (ESR) had a minimum value when 0.375 wt % of the first filler 121 (core-shell rubber) was added, and had a value similar to that of the comparative example when 0.75 wt % of the first filler 121 (core-shell rubber) was added. The moisture absorption rate had a minimum value when 0.6 wt % of the first filler 121 (core-shell rubber) was added.

A content of the first filler 121 may be determined using the following method. As illustrated in FIG. 3, the tantalum element body 110 in the first direction (X-direction) may be cut in a ratio of 1:2 to obtain a cross-section illustrated in FIG. 4. An area of the first filler 121 relative to an area of the conductive polymer layer 120 may be measured by selecting an arbitrary ten regions, spaced apart from each other, of the exposed conductive polymer layer 120 from a collected cross-section sample. As an example, ten regions having a square shape having an edge length of 5 μm may be selected to be spaced apart from each other, but the present disclosure is not limited thereto.

Thereafter, a ratio of an area of the first filler 121 to an area of the conductive polymer layer 120 in a plurality of regions may be measured using measurement equipment such as a scanning electron microscope (SEM) or the like. During the measurement, a magnification of the SEM may be *15,000 or more, and an acceleration voltage may be 10 kV or more, but the magnification and the acceleration voltage may be changed, as necessary. Other methods and/or tools appreciated by one of ordinary skill in the art, even if not described in the present disclosure, may also be used.

The “area” of the conductive polymer layer 120 or the first filler 121 may refer to an area occupied by each component on a cross-section. In the present disclosure, the first filler 121 may be a component included in the conductive polymer layer 120. Thus, in the present disclosure, the area of the conductive polymer layer 120 may be interpreted as including the area of the first filler 121. That is, the area of the first filler 121 may not be greater than the area of the conductive polymer layer 120.

The second filler 122 to be described below may also be a component included in the conductive polymer layer 120. Thus, in the present disclosure, the area of the conductive polymer layer 120 may be interpreted as including both the areas of the first and second fillers 121 and 122. That is, in the description of the “area” of the present disclosure, a sum of the areas of each of the first and second fillers 121 and 122 or the areas of the first and second fillers 121 and 122 may not be greater than the area of the conductive polymer layer 120.

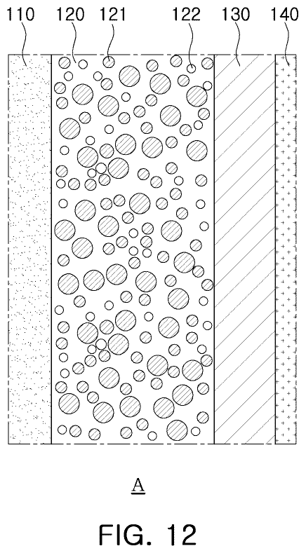

FIG. 12 is an enlarged view of region “A” in FIG. 4 of a tantalum capacitor according to a modification.

Referring to FIG. 12, in the tantalum capacitor according to a modification, a second filler 122 may be dispersed in a conductive polymer layer 120.

The conductive polymer layer 120 according to the present disclosure may further include the second filler 122 including at least one from the group consisting of the graphene, carbon nanotubes, and black carbon. The conductive polymer layer 120 may include the second filler 122 formed of conductive particles, thereby easily adjusting a thickness of the conductive polymer layer 120 on a central portion of a tantalum element body 110.

Specifically, in a process of forming the conductive polymer layer 120 on the tantalum element body 110, the one or more conductive particles, among the graphene, carbon nanotubes, and black carbon, may cause a coffee ring effect.

That is, a polymer slurry including the one or more conductive particles, among the graphene, carbon nanotubes, and black carbon, may begin to evaporate from an edge surface of the tantalum element body 110, and a particle density of the primarily evaporated portion may increase. A surrounding slurry and particles may be further pulled due to the increased particle density and high solid content, thereby increasing the thickness of the conductive polymer layer 120 disposed on an edge portion of the tantalum element body 110.

In addition, according to an example embodiment of the present disclosure, the conductive polymer layer 120 may adjust an equivalent series resistance (ESR) of the tantalum capacitor to a desired level by selectively selecting particles having different conductivity, among the graphene, carbon nanotubes, and black carbon.

A coating film may be formed on a surface of the second filler 122. As the coating film, a metal oxide may be used.

Other features may be the same as the above-described features of the tantalum capacitor according to an example embodiment of the present disclosure, and thus detailed descriptions thereof will be omitted.

While example embodiments have been shown and described above, it will be apparent to those skilled in the art that modifications and variations could be made without departing from the scope of the present disclosure as defined by the appended claims.

What is claimed is:

1. A tantalum capacitor comprising:
a tantalum body including:
a tantalum element body including tantalum particles,
a conductive polymer layer disposed on the tantalum element body, the conductive polymer layer including a first filler, and
a tantalum wire,
wherein the first filler is an insulating polymer filler.

2. The tantalum capacitor of claim 1, wherein the first filler has a core-shell structure.

3. The tantalum capacitor of claim 1, wherein the first filler is a silicone-epoxy copolymer.

4. The tantalum capacitor of claim 3, wherein the silicone-epoxy copolymer includes a silicone portion and an epoxy portion, and
the first filler includes:
a core that includes the epoxy portion, and the silicone portion covering the epoxy.

5. The tantalum capacitor of claim 3, wherein, with respect to one cross-section of the conductive polymer layer, a ratio of an area of the first filler to an area of the conductive polymer layer is greater than 0 and less than or equal to 0.0976.

6. The tantalum capacitor of claim 5, wherein, with respect to the one cross-section of the conductive polymer layer, the ratio of the area of the first filler to the area of the conductive polymer layer is 0.00976 to 0.0488.

7. The tantalum capacitor of claim 1, wherein the first filler is a core-shell rubber.

8. The tantalum capacitor of claim 7, wherein
a core of the first filler includes at least one from the group consisting of butadiene rubber, acrylic rubber, and silicone rubber, and
a shell of the first filler includes at least one of methyl methacrylate and styrene.

9. The tantalum capacitor of claim 7, wherein, with respect to one cross-section of the conductive polymer layer, a ratio of an area of the first filler to an area of the conductive polymer layer is greater than 0 and less than or equal to 0.00734.

10. The tantalum capacitor of claim 9, wherein, with respect to the one cross-section of the conductive polymer layer, the ratio of the area of the first filler to the area of the conductive polymer layer is 0.00368 to 0.00588.

11. The tantalum capacitor of claim 1, wherein the conductive polymer layer includes poly (3,4-ethylenedioxythiophene): poly(styrene sulfonate) (PEDOT: PSS).

12. The tantalum capacitor of claim 1, wherein the conductive polymer layer further includes a second filler which is a conductive particle.

13. The tantalum capacitor of claim 12, wherein the conductive particle includes at least one from the group consisting of graphene, carbon nanotubes, and black carbon.

14. The tantalum capacitor of claim 1, wherein the tantalum body further includes:
a carbon layer disposed on the conductive polymer layer; and
a silver (Ag) layer disposed on the carbon layer.

15. The tantalum capacitor of claim 1, further comprising:
a molded portion having fifth and sixth surfaces opposing each other in a first direction, third and fourth surfaces opposing each other in a second direction, and first and second surfaces opposing each other in a third direction, the molded portion surrounding the tantalum body;
an anode lead frame exposed from the second surface of the molded portion, the anode lead frame connected to the tantalum wire; and
a cathode lead frame spaced apart from the anode lead frame, the cathode lead frame exposed from the second surface of the molded portion.

16. The tantalum capacitor of claim 3, wherein the conductive polymer layer includes the first filler in an amount that is greater than 0 wt % and less than or equal to 10 wt %, based on a total weight of the conductive polymer layer.

17. The tantalum capacitor of claim 1, wherein the conductive polymer layer directly contacts the tantalum element body.

18. The tantalum capacitor of claim 8, wherein the shell includes methyl methacrylate.

19. The tantalum capacitor of claim 8, wherein the shell includes styrene.
